(19) United States
(12) Patent Application Publication
(10) Pub. No.: US 2021/0407504 A1
(43) Pub. Date: Dec. 30, 2021

(54) GENERATION AND OPERATION OF ARTIFICIAL INTELLIGENCE BASED CONVERSATION SYSTEMS

(71) Applicants: David COLLEEN, (US); Maclen MARVIT, (US)

(72) Inventors: David COLLEEN, Santa Cruz, CA (US); Maclen MARVIT, Santa Cruz, CA (US)

(21) Appl. No.: 17/099,952

(22) Filed: Nov. 17, 2020

Related U.S. Application Data
(63) Continuation of application No. PCT/US2020/040375, filed on Jun. 30, 2020.

(51) Int. Cl. G10L 15/22; G06N 5/02; G06N 5/04; G06F 16/2458

(52) U.S. Cl. CPC G10L 15/22; G06N 5/02; G10L 2015/223; G06F 16/2465; G06N 5/04

(57) ABSTRACT

A computer process provide for users employing a conversation program to dynamically program automated assistants with information and processes that can later be invoked to accomplish task(s) on one or more of the users' devices. The conversation program might generate an automated assistant from a text or graphic source. The conversation program might access multiple automated assistants and determine which is most appropriate to use in order to address a user's request. The user can generate avatars for the conversation program that parallel human emotion, facial expression and body gestures that can be displayed in visual context. A resulting automated assistant can be used for software system testing.

### CROSS-REFERENCE TO RELATED APPLICATIONS

This application is a Continuation of PCT/US2020/040375, filed Jun. 30, 2020, which is incorporated by reference herein for all purposes.

### FIELD OF THE INVENTION

The present disclosure generally relates to methods, systems, and programs for creating artificial intelligence conversation systems.

### BACKGROUND

An artificial intelligence (“AI”) conversation program might be used to provide information retrieval, technical assistance (e.g., customer support), control of devices, media control, game play, storytelling, and general conversation with humans. Some AI conversation programs might be referred to as “chatbots,” “automated assistants”, “digital assistants,” “interactive personal assistants,” “intelligent personal assistants,” “personal voice assistants,” “conversational agents,” etc.). Such system may accept audio, text, mechanical or sensor input and respond in kind and/or store records or representations of the interaction in memory, such as storing records in a database.

Different conversation systems may be created for different purposes and for different input languages. If a user is interacting with a conversation system not suiting to the user's purpose or language, the results may be unsatisfactory.

The process of manually authoring human-like voice or text responses for the conversation program to draw on is time consuming and expensive. For example, an automated interaction system that listens to a user request and responds appropriately might be created by having a team of programmers input all the possible user requests and the appropriate responses. This might be feasible for a system that has a limited repertoire, such as an automated interaction system where a user can state a date and a city and have the automated interaction system respond with the expected weather on that date in that city. But where the possible interactions are much broader, it can be very time consuming to author such an automated interaction system.

Because it is time consuming, authoring an automated interaction system is often done offline and cannot generate new responses to unanticipated user input. Even though a large corpus of prepared responses may be created, the corpus will necessarily only provide responses to predicted user interaction, limiting its usefulness. Systems which take limited, predictable inputs are commonly referred to as “chatbots.” Because the possible responses of the system are limited and may deliver faulty responses, the system can frustrate the human user. Some systems may attempt to extract data from web pages and other sources for possible answers, but these systems can provide unhelpful results. Current systems using statistical, machine learning approaches might fail to respond to users in normal conversational patterns. There is a need for an automated, real-time approach to dialogue and response creation in building an automated interaction system.

Additionally, users interact with multiple devices every day, and each device has its own set of preferences and modes of interaction. This requires a user to configure or train each device separately. The time it takes to learn how do use each of these devices can be frustrating for a user.

### SUMMARY

In a computer implemented method, an automated interaction system authoring system generates structured data that is used to drive the operation of the automated interaction system and that structured data is formed by a structuring system from natural language inputs. Interaction with the automated interaction system can be in the form of natural language inputs, structured inputs, etc.

The automated interaction system might use a speech recognition module to obtain input. The automated interaction system might take in an input and give out and output, along with a confidence value for the output representing a computation to determine how confident the automated interaction system is that the provided output would be an appropriate and/or useful response to the received input.

In some embodiments, the automated interaction system is authored for use by a particular entity, such as a business entity, with the expectation that the entity's customers or users would give inputs to the automated interaction system and get back responsive outputs. In a specific case, the user is a customer and asks questions, in text, voice, etc., of the automated interaction system and the automated interaction system outputs text, voice, etc. that the automated interaction system deems responsive to the questions.

The automated interaction system might be a conversation system.

The automated interaction system might compute a plurality of possible responses, each with a confidence value, and output the output corresponding to the highest confidence value.

The automated interaction system might process an input from a user, such as a user voice input, with a plurality of automated speech recognizers, determining a corresponding confidence value for such processing, and use one automated speech recognizer of the plurality of automated speech recognizers based on the corresponding highest confidence value for future interactions with that user.

### BRIEF DESCRIPTION OF THE DRAWINGS

Various embodiments in accordance with the present disclosure will be described with reference to the drawings, in which:

FIG. 1 shows an exemplary computer system.

FIG. 2 shows an exemplary vehicle, robot or medical device system with an internet connection.

FIG. 3 shows an exemplary vehicle, robot or medical device system without an internet connection.

FIG. 4 shows an exemplary vending machine system without an internet connection.

FIG. 5 shows an exemplary vending machine system with an internet connection.

FIG. 6 shows an exemplary vending machine system with an internet connection and an accessory robot.

FIG. 7 shows an exemplary motorcycle and helmet system with an internet connection.

FIG. 8 shows an exemplary alternative motorcycle and helmet system with an internet connection.

FIG. 9 shows an exemplary mobile phone or smart watch system with an internet connection.

FIG. 10 shows an exemplary motorcycle and helmet system with an internet connection.

FIG. 11 shows an exemplary interactive voice response or audio conferencing system for telephony.

FIG. 12 shows an exemplary smart speaker or video conferencing system.

FIG. 13 shows an exemplary conversation system.

FIG. 14 shows an exemplary social media system.

FIG. 15 illustrates a system in which a structuring system generates data usable by an automated interaction system.

The following detailed description together with the accompanying drawings will provide a better understanding of the nature and advantages of the present invention.

### DETAILED DESCRIPTION

Using systems described herein, an improved automated interaction system, which might be a conversational system, can provide on-demand information and entertainment, give menu options in telephone systems, provide basic control of devices, provide alternative computer interfaces to disabled users, and/or automatically detect the language that a user is speaking and react accordingly. Other inputs might include data indicative of a user's emotional state where such data might be generated using sentiment analysis or other techniques to determine such state, which can then be used in adjusting the output of the automated interaction system.

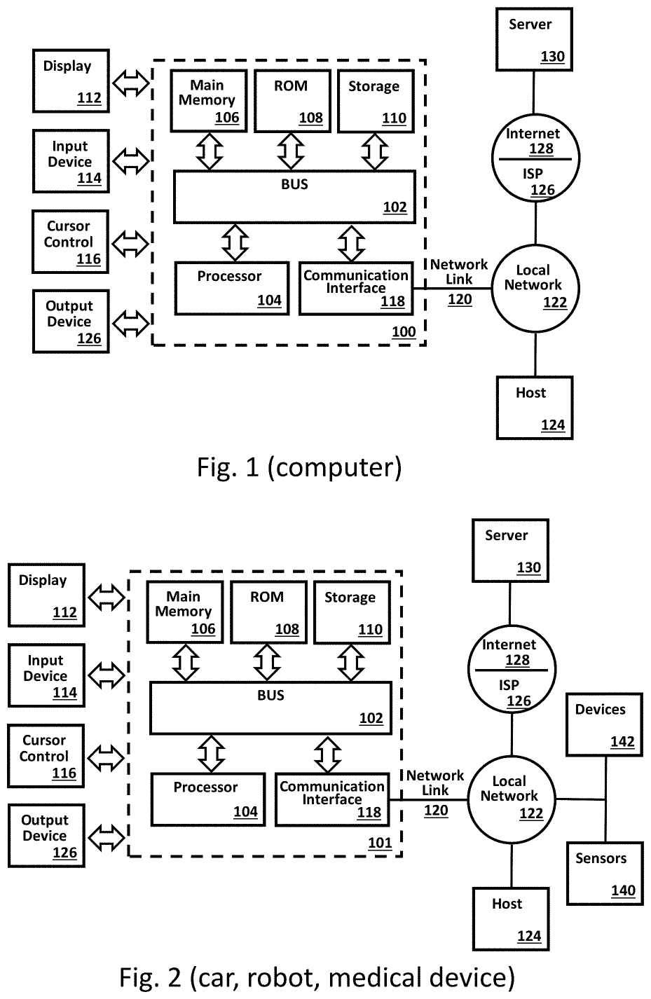

FIG. 1 illustrates a block diagram of processes implemented to subscribe a user to a conversation channel with another user in accordance with an embodiment of the present invention. The processes are carried out on a conversation management server. In process 11, the server receives a search request over a first network from a device, under control of the user, to indicate that the user device is running a process configured to support a managed conversation session. A search signal, such as a signal originating from a user device to indicate that the user device is running a process configured to support a conversation session managed as described herein, can include data characterizing criteria for a remote user with which the user seeks to interact with. In some cases, that remote user is an automated interaction system authored as described herein.

A conversation session might involve a participant interacting with a computer interface wherein the participant provides some input and gets some output back, with one or more cycles of input and output. The interaction might be over a network connection and the inputs and/or outputs might be in the form of text, video, audio, and/or data. In some conversation sessions there are two participants and in some conversation sessions, at least one participant is human and at least one participant is a computer process. A conversation session might have a logical or physical conversation channel associated with the conversation session, wherein participants might be registered with a conversation server. In some embodiments, a conversation server maintains data about who is a participant in a conversation session. In a general case, the hardware/software that provides an interface for a participant might be considered a “seat” that corresponds to a node in a conversation.

In some cases, a conversation channel is operated by or for a particular business or organization (a conversation channel beneficiary) and has data associated with its state, such as an “availability status” that represents whether a conversation channel is available and opened for the conversation channel beneficiary associated with the conversation channel. Other state data might include availability ratings of the conversation channel, a responsiveness rating of the conversation channel beneficiary, and rulesets associated with the conversation channel beneficiary. In a specific embodiment, availability status might be selected from a set of statuses that include “away,” “off;” “busy,” “online,” and “open to receive messages even though not available for immediate conversation.” Parties to a conversation need not necessarily be online simultaneously in order for a conversation channel to be opened for those parties.

Some users might be registered users, who have an account in a conversation session management system, and some users might be associated with a particular conversation channel beneficiary, such as employees of a business user that has a claimed business that has an associated conversation channel.

A conversation channel might be considered by computer systems as a communication path between a user and a seat in a business selected by the user for engaging in conversation. Claimed businesses might have at least one conversation channel, and a claimed business may define a plurality of conversation channels, wherein each conversation channel can be assigned to a category of communication with the business. Each channel can be provided with a label that is visible to a user, so that the user can select a desired channel of the claimed business over which to engage in conversation.

A seat of a conversation session might correspond to a conversation node that is staffed by a seat operator, such as an individual, a computer process, or an installed application, where the seat operator is a representative of, or an interface to, a given business in conversation sessions. When a user seeks to converse with a business having a plurality of seats, it might be that a conversation management server subscribes that user to converse with a seat of the business that is not currently engaged in conversation (or which currently has sufficient capacity to engage in conversation) with the user (assuming of course that the seat is being occupied by an individual representing the business in conversation).

A seat might have a state of being busy if a number of concurrent conversation sessions associated with the seat reaches a pre-specified threshold.

A conversation host might be an individual or group for which there has been established a personal account to host a conversation and for which there is at least one assigned seat.

A computer process might perform a described function in a computer using computer hardware (such as a processor, field-programmable gate array or other electronic combinatorial logic, or similar device), which may be operating under control of software or firmware or a combination of any of these or operating outside control of any of the foregoing. All or part of the described function might be performed by active or passive electronic components, such as transistors or resistors. A computer process does not necessarily imply a schedulable entity, or operation of a computer program or a part thereof, although, in some embodiments, a computer process may be implemented by such a schedulable entity, or operation of a computer program or a part thereof. A process might be performed using more than one processor or more than one (single- or multi-processor) computer.

User devices might be computers that are used by users and implemented as a desktop unit, a laptop unit, a tablet, a smartphone, or as any other computer having access to a network.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Various components of an exemplary system might be used alone or in combination with other elements, to form a computerized interactive system wherein a user might interact with the computerized interactive system and the computerized interactive system takes in input from that user, performs some processing and/or data lookup, and then outputs its system output in the form of audio and/or video, with other outputs possibly, such that the user might perceive the computerized interactive system as having some intelligence in being able to respond appropriately to the user. In order to accomplish this, the computerized interactive system might have some training modes as well as operational modes. For example, the computerized interactive system might first be trained so that it can output voice phrases, and then in an operational mode, using those voice phrases.

Techniques described herein relate to allowing users to employ a conversation program to dynamically program automated assistants with information and processes that can later be invoked to accomplish task(s) on one or more of the users' devices. In another implementation, the conversation program would generate the automated assistant from a text or graphic source such as Wikipedia. Further, the conversation program would be able to access multiple automated assistants and determine which was the most appropriate to use in order to address a user's request. Another implementation would allow the user to generate avatars, for the conversation program, that parallel human emotion, facial expression and body gestures that can be displayed in a plethora of visual contexts. The resulting automated assistant(s) can also be used for software system testing.

### 1. Selection of Automated Speech Recognition Engine Based on Confidence Values

In some automated conversation systems, multiple AI conversation systems may be available. Picking an AI conversation system which is best suited to assist a user can create an improved user experience.

In one embodiment, a conversation system may have access to multiple automated speech recognition engines (“ASRs”), for example for different languages, different accents within the same language, and dialects of the same language. For example, a system may have a different automated speech recognition system for each of Portuguese, Spanish, American English, Scottish English, and English as spoken by non-native speakers from Spanish speaking countries. The conversation system may also have an ASR for children, an

ASR for people with speech impairments, etc.

Each ASR engine receives voice input and translates it to output text. The ASRs also label the output text with a confidence value, which may range, for example, from 0 to 1, though other ranges are contemplated. When voice input is received by the conversation system, a subset or all of the ASRs may be used to translate it to text, resulting in text output and a confidence value for each ASR. The output from the highest ranked ASR may be selected as the output. If the user inputs further voice input, the previously chosen ASR may be given a higher weight. In another embodiment, each voice input may be handled independently. The ASRs may also be evaluated, and if ASRs have confidence values that are within a range, the previously chosen ASR may be used until its confidence values is exceeded by another ASR's confidence interval by a threshold value.

In one embodiment, the ASRs may be stored in a remote data center (the “cloud”) and only an active ASR may be downloaded for local use, but the voice input may be sent to the remote data center to monitor the confidence intervals of other available ASRs and, should a different ASR exceed the confidence interval of the active ASR (perhaps by a threshold), the different ASR may be downloaded and replace or run alongside the active ASR. The local system may use two or more ASRs for a period until one ASR achieves a series of higher confidence intervals or has a statistically significant higher confidence interval over multiple voice inputs.

In another embodiment, multiple ASRs may be available in the cloud when the conversation system has a high bandwidth connection available. The cloud system may track which ASR has the highest confidence value and download that ASR to the local conversation system when a high bandwidth connection is available. When the high bandwidth connection is not available, the local ASR may be used, and the voice input cached. Once a high bandwidth connection is once again available, call cached interaction may be sent to the cloud for evaluation and, if a different ASR has a higher confidence value than the previous ASR, a new ASR system may be downloaded to the local conversation system.

2. AI Interviewing to Create Conversation System from Reference Corpus and SME

One embodiment is an AI-driven interviewing system for generating a corpus usable for conversions. In this embodiment, a user interacts with an authoring system, either via text or speech. The authoring system may ask a series of questions, including, for example, what the new conversation system is to be named, what the avatar is to look like, what the voice should sound like, what the verbal style of interaction is to be, and what fields of expertise the new conversation system is to have. Possible avatars may be provided in an avatar database of possible avatars or features of avatars that a user may select from.

In some embodiments, natural language authoring inputs are used to author an automated interaction system, in part by generating structured data corresponding to concepts, rules, patterns, and/or algorithms that might inform operations of the automated interaction system. The authoring inputs might be specific instructions for an author to vocally generate inputs and output statements, design rules, and might use a summarization system to suggest inputs.

The system may have a database of voices indexed by different voice properties that allows a user to select and listen to different voices. The authoring system may have different conversation styles available, such as “chatty”, “scholarly”, and “terse.” The authoring system may have a menu of known knowledge bases from which the user selects what knowledge the new conversation system will provide. The authoring system may store the user's responses in a database.

Once the user has defined the properties of the new conversation system, either by interacting with a standard graphical based user interface or by voice, the authoring system may prompt the user for further information to add to the knowledge base, for example by asking the user to input information. This information may be provided to a knowledge base system, which may then extract further information from online sources, for example

Wikipedia. The knowledge base system may exchange information with knowledge base systems for other conversation systems. In some embodiments, the knowledge base system may have access to books or technical literature, which the knowledge based system may use to augment and confirm input information. If conflicting data is found, the user may be presented with the conflict and asks which information takes precedence. The knowledge based system may also extract text from video sources, lidar sources, etc., relevant to the subject of the new conversation system.

### 3. Voice Authoring Component

In one embodiment, as part of the creation of the conversation system by the authoring system, the authoring system may have its own AI conversation interviewing system which is configured to interview a subject matter expert (“SME”) and record the responses. The interviewing system will discover follow-up questions to ask based on the SME responses.

The interviewing system is configured to generate questions that prompt responses from the SME that are more likely to contain voiced phrases that would be useful in an interactive voice system. For example, the interviewing system might have a “shopping list” of voiced phrases it needs to obtain and the SME determines questions to ask that correspond to those voiced phrases being spoken as answers to those questions.

The phrases can be stored in a text-to-voice database as well as added to the knowledge base. As the authoring system is interviewing the SME, the output may be stored in the knowledge base, which may concurrently compare the content to other knowledge bases to detect if, for example, a similar data has been entered and use that similar data to generate focused questions during the SME interview. These focused questions may be based on past user interaction with a previously created conversation AI system, such as common end user questions.

In one example system, a knowledge base may be used by a speech system to generate instructions for an automobile user. The speech system might already have some voiced phrases, but not have some that are in turn needed for other parts of the knowledge system. For example, if there is already a database describing how a user interacts with the seat adjustments in a car, that data may be used to generate focused questions in the interview question.

### 4. Multimodal Conversation Component

A multimodal conversation system may be used for compiling, storing, and reviewing device-independent user voice interface personalizations.

In this embodiment, user preferences may be stored in a data store, for example a blockchain ledger, which is accessible from multiple devices. In another embodiment, user preferences may be stored in an encrypted format, for example, symmetric key encryption or public/private key encryption. A 256-bit encryption key may be used for enhanced security.

In one embodiment, preference information such as a user's birthday, leisure activities, or favorite color are stored. The preferences may be device or user specific. The user may make a request of an AI conversation system for a request later in the day, for example a reminder. The AI conversation system receives the request and tags it with a time tag, storing the information in a central database. At the appointed time, it may happen that the user is not near the original AI conversation system to which the user made the request. The system recognizes this and routes the request to an AI conversation system that is close to the user for a response.

In another embodiment, a user tells an AI conversation system, for example, that their favorite color is blue. The color preference is stored in a central database. Later, when the user is interacting with a different AI conversation system, the user may make a request which is relevant to the user's favorite color (e.g., “conversation system, pick a theme for my UI that has nice colors”). This second conversation system may poll the central database to find the information, and pick a UI for the system, with the comment that it picked the theme based on the user's favorite color, blue.

### 5. Determining User Intent and Selection of an AI Variant Based on User Intent

A conversation system may include a preprocessor for determining user intent and selection of an AI variant based on user intent. Different AI conversation systems may be better suited for particular types of user interactions than other systems. A preprocessor may determine the user's intent and then classify the user intent. From the classification, the preprocessor may select from among a plurality of AI conversation systems. A rule based preprocessing system may generate a general representation of a conversation. For example, the representation may indicate that a user is asking technical questions and invoke a system designed to extract answers from technical literature. An example of a system designed to answer technical questions is the open source machine learning system developed at Stanford University that answers tech support questions based on technical literature. Because there are many different types of AI tools, selecting the best AI tool for a given user task may provide an enhanced user experience. Determining the user's intent (e.g., find an answer to a technical question) can determine the success of the chosen AI conversation system in providing the user with the sought information.

In one embodiment, the preprocessor system would select from several specialized AI conversation systems, creating a meta AI conversation system comprising multiple AI conversation systems. The preprocessor may take the following steps: A user asks a question of the meta AI conversation system. The preprocessor analyzes the intent of the user's question and classifies it by type. The preprocessor system compares the intent type to a list of on-board or online AI conversation systems ranked by response accuracy for given intent types.

An automated interaction system might even process inputs and provide outputs consistent with one or more of a plurality of “mindsets” that results in the outputs being at least somewhat consistent with a specific mindset.

The accuracy may be a variable value that can take on a wide range of values and have a value that corresponds to a confidence in a match. This value can be used as an estimate of the quality of the match to determine if the conversation system is initially well matched to the user's questions. From this list, the preprocessor selects the best conversation system to answer the question. In another embodiment, the preprocessor may select multiple conversation systems. The question is sent to the chosen specialized conversation system(s) for processing. When the specialized conversation system generates the answer, the answer is spoken by the meta conversation system's dialogue generator. If multiple conversation systems are used, the responses can be scored (using, e.g., and integer or floating point score) on how confident the system is that the response matches the user question. Based on this score, the active conversation system may be changed from a previously chosen conversation system to a conversation system having a higher confidence score.

### 6. Generating Dynamic Characters for Augmented Reality (“AR”) or Virtual Reality (“VR”) Based on Video

AR and VR are both 3D technologies, though in AR the background is a live video feed while in VR the background can be a single panoramic image or a pre-recorded video image. In either case, there are computer-generated characters in the video. Those characters can be AI-driven conversational characters, which might act as guides, assistants, or characters in stories or games. Other display devices might include computer screens, projected video, retinal display and mixed reality (“XR”).

A character generating system may add a real-world character (either live capture or pre-recorded) to the AR/VR feed. The character generating system may superimpose a 3D rendered face over the face of the real-world character in the video and drive animation of the superimposed face with an AI system.

The character generating system may user machine vision to perform the following steps to generate a character that can be used in later video compositing. First, the character generating system may locate existing faces in the video scene. Next, the character generating system may analyze facial color to generate a color palette adjustment layer. Then, it may analyze shading and shadowing of the face to generate a shading adjustment layer. It may then modify an existing a 3D mesh representing a 3D model of each face in the video scene to align with key facial features in the video face (“a target face”).

After these steps are performed, a video compositing system may then calibrate the video faces for their centroid, pitch, roll, and yaw. It may then calculate occlusions to these video faces. It may then generate an animated ‘mask layer’ that describes occlusions, including an alpha channel to aid in edge feathering. The video compositing system may then build a rigged, generic 3D face model that may then be conformed to the target face model using morph or other targeting approaches. The 3D face model may then be animated in real-time based on animation cues generated by outputs from an AI conversation system.

The video compositing system my received position data for the generic face model from calibrating the video faces for their centroid, pitch, roll, and yaw. The video compositing system may receive a texture map based on color information from analyzing facial color and apply the texture map to the generic face model. The video compositing system may also receive shading information from analyzing shading information and shadowing information and apply the shading information to the texture map. The video compositing system may also apply occlusions, if any. The video compositing system may animate the face using a natural language understanding (“NLU”) engine to display speech and facial emotions. The video compositing system may the render the generic face model and composite it over the background video using alpha blending to blend it with the pixels of the video. The video compositing system may make the rendered character appear to be speaking dialogue in its own voice, with accompanying facial animation, which matches the output of the AI conversation system, as opposed to a prepared (or “canned”) response. The video compositing system provides a fully dynamic character driven by the AI.

7. An Authoring Component that Generates Conversational Output from Data Sources

The authoring system may include a method for converting a technical document, such as a car manual, to a database using machine learning. An AI conversation system may be able to retrieve information from the database and output it as voice audio in response to voice questions asked by the user. The conversation system would use a method starting by comparing the user questions to a known set of human response approaches from those stored in a database. The conversation system would then add personalization such as adding the user's name or formatting to simulate human conversation. The system would then insert numbers or other specific data to fill in variables in the known human responses. The specific data may be supplied by the database created by machine learning. The conversation system may then verify that the response is grammatically correct.

The machine learning platform may be one which is focused on answering questions from technical texts by identifying the location of the answer data. The conversation system then formats this as a conversation. For example, when asked the question, “How many cylinders does a V8 have?” the machine learning system may identify that the answer is 8. The conversation system may then formulate the reply, including the user name, “a V8 has eight cylinders arrayed in a V shape.” The system may also perform cross referencing to assemble a more thorough answer.

Technical drawings, such as exploded views of automotive parts assembly, may be analyzed using classification, segmentation, and labeling techniques. As an example application, car manuals may be read into a database to provide user support. Another application could be parts catalogs for automobiles.

A method executed by the authoring system may include using OCR technology to scan an existing manual. The manual may have text, graphics, and labels for the graphics correlating them to the descriptive text. Caption text or other descriptive text associated with the graphic may be identified and stored. The authoring system may scan the graphic to locate this descriptive text and store it in a database. Identifying markers, such as arrows, may be identified and (x, y) coordinates of the location indicated by the identifying marker (e.g., the tip of the arrow) may be saved. The authoring system may then compare the saved OCR text to the descriptive text corresponding to the graphic to determine if there is a correlation to the general OCR text to the graphic's descriptive text. If there is a correlation, the correlation is saved in the database. In one embodiment, the correlation is stored as a tag. In another embodiment, the correlation may be saved using and index key or other correlation device. The authoring system may then create question and answer based on the created database. In another embodiment, when a user interacts with an AI conversation system that has access to the database created by the authoring system, the AI conversation system may create answers to identified user questions. In either case, when a user interacts with an AI conversation system having access to either the database itself or the responses to user questions, when words or responses are identified which have links (such as graphic tags or indexes), the corresponding graphic may be displayed as the conversation system produces the voice dialogue of the reply. If a graphic is large, the (x, y) coordinates of an identified (tagged) identifying mark may be zoomed into, highlighted, boxed, or otherwise indicated to help the user find the relevant marker. This might also be used in image analysis and region segmentation.

8. AI Conversation Component with Variable Verbosity

Sentiment cues may be used to alter aspects of an AI conversation system, such as varying length of a response. The sentiment may change with the user's responses, and the conversation system may periodically measure the user's sentiment and vary response verbosity according to the user's updated sentiment. The conversation system may determine sentiment from word based methods, from voice wave form analysis, or from machine vision which performs facial analysis.

In one embodiment, the conversation system may have settings for verbosity of high, medium, and low. The high setting may cause the system to create “chatty” responses, a medium setting may cause terse, direct responses, and the low setting may be just a beep or the flash of an icon to acknowledge that the user had been heard and an action executed. A more sophisticated implementation may use dynamic variability or a sliding scale to create more granularity in varying the length of the responses.

In one embodiment, the conversation system may take the following steps:
1. Analyze a user's utterances to determine the user's emotional state based on word usage.
2. Score and record the user's emotional state in a database.
3. Analyze the user's utterances to determine the user's emotional state based on the words spoken per minute, voice volume or prosody. Other waveform or video analysis may be also be used for scoring.
4. Compare the words spoken per minute to a database of known emotional states correlated to word frequency.
5. Score and record the user's emotional state in the same database.
6. Analyze the user's utterances to look for direct comments indicating the user's level of contentment with their interactions with the conversation system. For example, a user saying “quiet down” to the conversation system could be taken as a sign that they want less verbosity from the conversation system.
7. Score this and record changes in contentment.
8. Aggregate all user data stored in the database to achieve a composite score. The system would update this score periodically.
9. If the score indicates user contentment or a certain state of mind, it might be that no change occurs in the conversation system's level of response verbosity, whereas in other cases it might. If the score went up or down, the conversation system would adjust its verbosity accordingly.
   9. Avatar Interface Component with Facial Analysis Adjustments

Using this component, a conversation system can vary a state of an avatar's face based on machine-vision derived facial state analysis of a user. The conversation system may use natural language understanding software to enhance an avatar's conversational abilities by adding support for facial gesture recognition and the generation of human like facial gestures in our avatars.

As people speak, they supplement their spoken words with facial gestures and micro-expressions that convey the speaker's emotional state. For example, the blink of an eye can signal that a speaker is done talking. Further, a listener's facial expressions often reflect and interact with the facial expressions of a speaker. A conversation system may improve its avatar's performance by capturing video of the user, analyzing the user's facial expressions, recognizing facial expressions, and reacting to those facial expressions.

In one embodiment, the conversation system may use a video camera and machine vision software to capture and analyze a user's facial patterns as they speak. The system may then map these patterns to known emotional states and expressions. Analyzing these patterns adds to the system's model of a user's vocally expressed intents, which may in turn be used to animate an avatar face in human-like patterns.

In another embodiment, the conversation system may generate a blink of an avatar's eyes when our system is done speaking to signal to the user that the conversation system is done talking.

In another embodiment, the conversation system may use machine vision to analyze the body language of a user including their posture, body position, and hand gestures. The conversation system may then map these patterns to known emotional states and expressions. This body language information can augment the system's understanding of vocally expressed intents and be used by the system to animate an avatar face and body in human-like patterns. The body language information may be used to match human like responses to the avatar's speech response as well as facial and body animation. In one embodiment, the avatar response would be further conditioned by the design factors constituting their “personality”.

The conversation system may use a method of punctuating conversation system output based on visual states of an avatar face.

In one embodiment, the system may perform the steps of:
1. Detecting and analyzing a user's eye blinks using a video camera and machine vision software.
2. Cross reference the recorded blinks to a timeline that includes a transcription of the user's utterances.
3. Use software to reject non-punctuation related eye blinks by comparing blinks to a natural language understanding analysis of vocal concepts and patterns to determine likely places for punctuation to occur.
4. Capture a user's eye blinks and analyze and classify these eye blinks to determine which blinks were intended as punctuation (as opposed to dry eye blinks and the like).
5. Compare candidate punctuation blinks to voice analysis of likely punctuation points to find false positives.
6. Classify eye blinks correlated at the end of sentences as conversation handover points triggering the conversation system to respond to the last user utterance.

In another embodiment, the conversation system may focus on facial recognition and an avatar's reaction to a user's utterance in the form of facial animation of the conversational system's avatar with the following steps:
1. Detect and analyze user facial gestures using a video camera and machine vision software.
2. Cross reference the recorded facial gestures to a timeline that includes a transcription of the user's utterances.
3. Compare recognized facial gestures to a database of known emotional states.
4. Use this derived emotional state information to populate a scoring system based on variables such as trust, happiness, sadness, etc.
5. Compare the derived scores to a database of known facial responses typically used in human conversation.

These facial responses could be used to trigger pre-set animations shaping the conversation system's avatar's face.

Another embodiment may supplement or replace facial animation with hand gestures.

Another embodiment may supplement or replace facial animation with body positioning.

### 10. Processed User Voice Files Caching Component

Using this component, the conversation system caches processed user voice files in an interactive conversation system using lower resolution voice files for cache misses. Generating high quality speech takes much more computation than generating low quality speech, but sometimes, for example in real time systems, there isn't enough time to generate high quality speech. When a conversation system determines what a response should be, it checks a local repository to see if a version of that audio response exists. If no entry exists in the cache, the system generates a low quality version, plays it, and queues up a low priority process to generate a high quality version which gets stored in the local repository or on a server.

Conversation systems may respond to a particular user with the same response repeatedly, so generating a higher quality voice file will improve apparent quality. But other users may have a different set of common responses. Since the conversation system is likely to have bursty computational requirements, the low priority task should have plenty of time to do its computation without adversely affecting the responsiveness of the system.

In one embodiment, the system may use a file system as the repository where the words spoken are stored as a WAV file with the filename a SHA hash of the words. The system would hash the response, and then look to see if a file with the hash as the filename exists.

A further refinement would be an optimized way to decide which entries to discard when the repository fills up. If the system changed the modification date every time a file was used, then sorting the files by date and picking the oldest provides a simple way to identify the “least recently used” entry so it can be discarded. Alternatively, selection may be based on frequency of use or use prediction.

### 11. Regression Testing Component

Using this component, a conversational AI engine can handle test input variability. Software may be tested in a process called regression testing. In regression testing, known inputs are stored in a database and used sequentially by a software program as part of a test system to locate failures. Conversation system systems take a user's written or voice input, process this input to determine the user's intent and deliver a response. To effectively test a conversation system, testing as many possible voice or text expressions of the user's intent is desirable.

Adding variability to test inputs by varying words and concepts using a natural language understanding software engine produces variable input that may more robustly test a conversation system. In one embodiment, a test system takes the inputs from a regression test and generate permutations to add variability and depth in the form of new tests. These permutations would be generated from pre-defined concept definitions. As an example, the user utterance “Does Alex like fishing?” could be permutated by the following concepts ˜male_names (Alex, Bob, Charlie, Dave, Ernie, Frank) and the concept ˜sports (fishing, kite_flying, hiking). A resulting permutation might then be “Does Bob like hiking?” The permutations would be added to the regression testing database to add depth and variability to the testing. In some embodiments, the system might vary the prosody, accent or dialect of the voice input.

### Example Hardware

The systems described above may be implemented on one or more computing systems.

According to one embodiment, the techniques described herein are implemented by one or generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

For example, FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Processor 104 may be, for example, a general purpose microprocessor.

Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Such instructions, when stored in non-transitory storage media accessible to processor 104, render computer system 100 into a special-purpose machine that is customized to perform the operations specified in the instructions.

Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a computer monitor, for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 may implement the techniques described herein using customized hard-wired logic, one or more ASICs or FPGAs, firmware and/or program logic which in combination with the computer system causes or programs computer system 100 to be a special-purpose machine. According to one embodiment, the techniques herein are performed by computer system 100 in response to processor 104 executing one or more sequences of one or more instructions contained in main memory 106. Such instructions may be read into main memory 106 from another storage medium, such as storage device 110. Execution of the sequences of instructions contained in main memory 106 causes processor 104 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 110. Volatile media includes dynamic memory, such as main memory 106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 102. Transmission media can also take the form of acoustic or light waves, such as those generated during radio-wave and infra-red data communications.

Various forms of media may be involved in carrying one or more sequences of one or more instructions to processor 104 for execution. For example, the instructions may initially be carried on a magnetic disk or solid state drive of a remote computer. The remote computer can load the instructions into its dynamic memory and send the instructions over a network connection. A modem or network interface local to computer system 100 can receive the data. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be a cable modem, satellite modem, or a modem to provide a data communication connection to a corresponding type of telephone line. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are example forms of transmission media.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

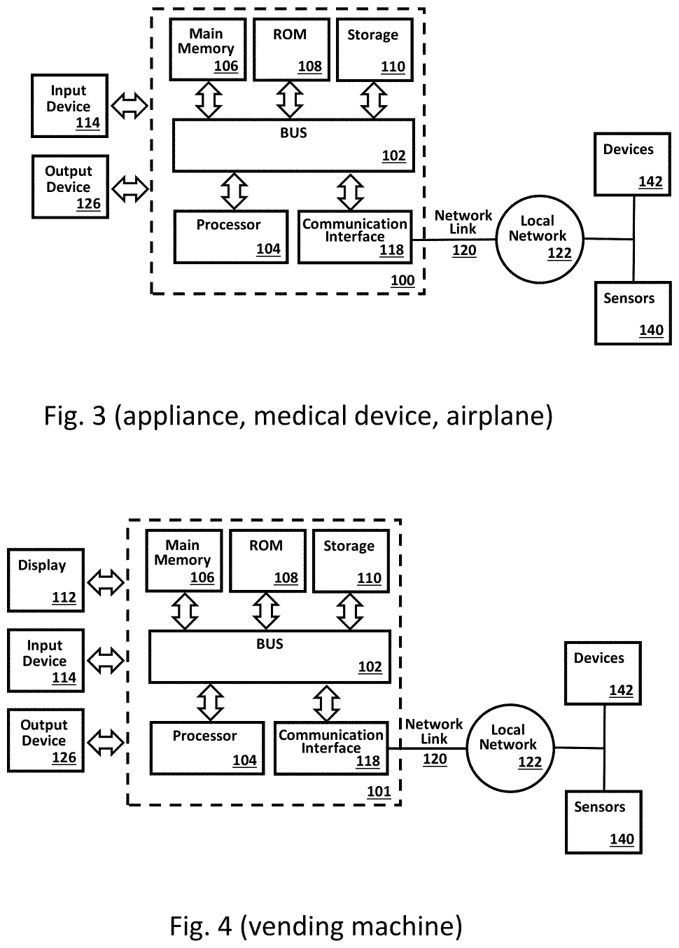

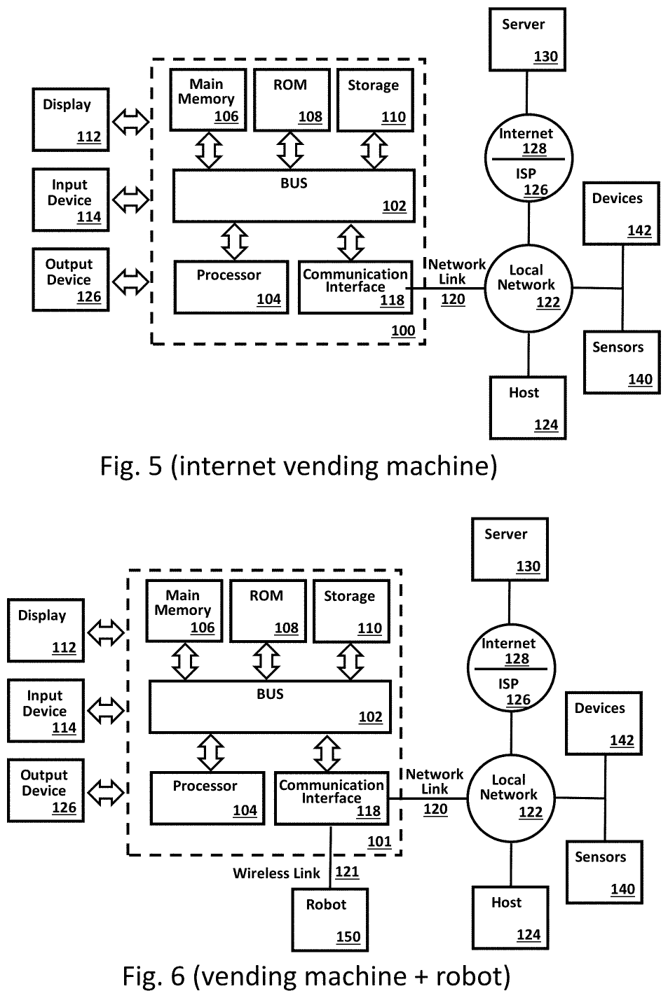

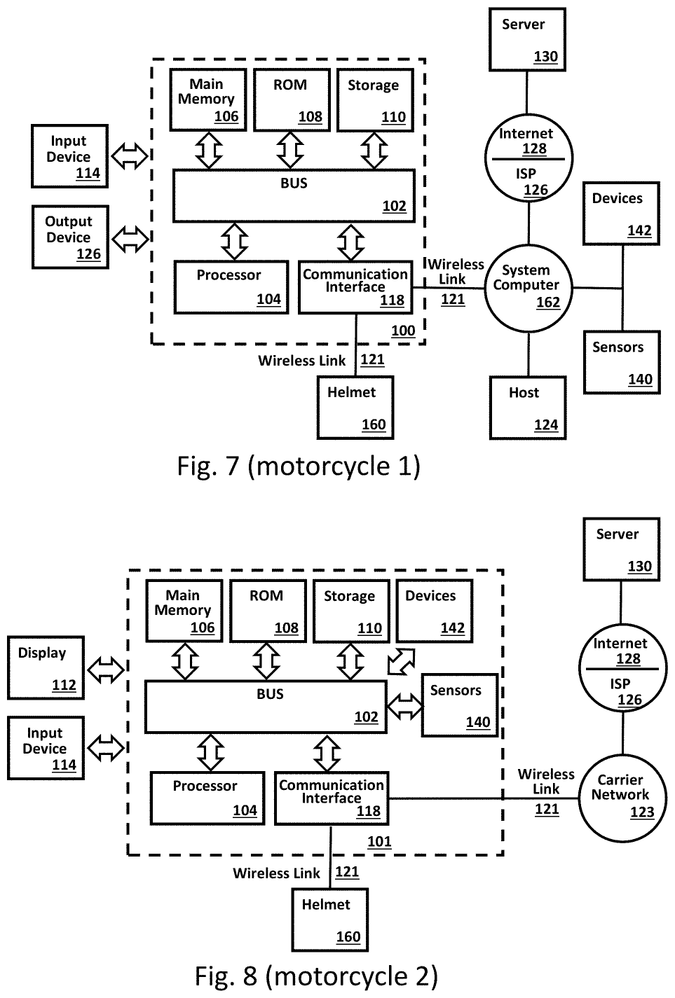

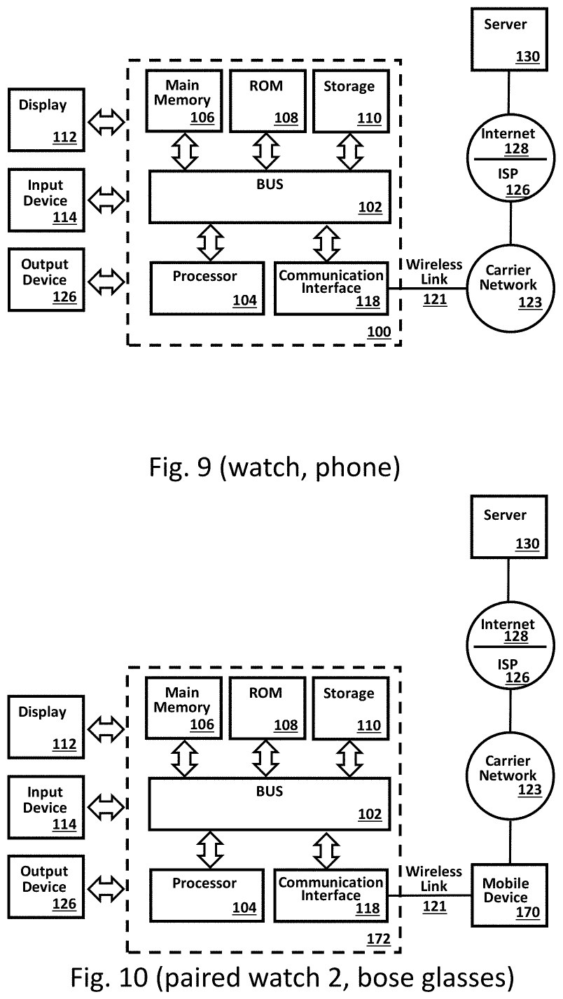

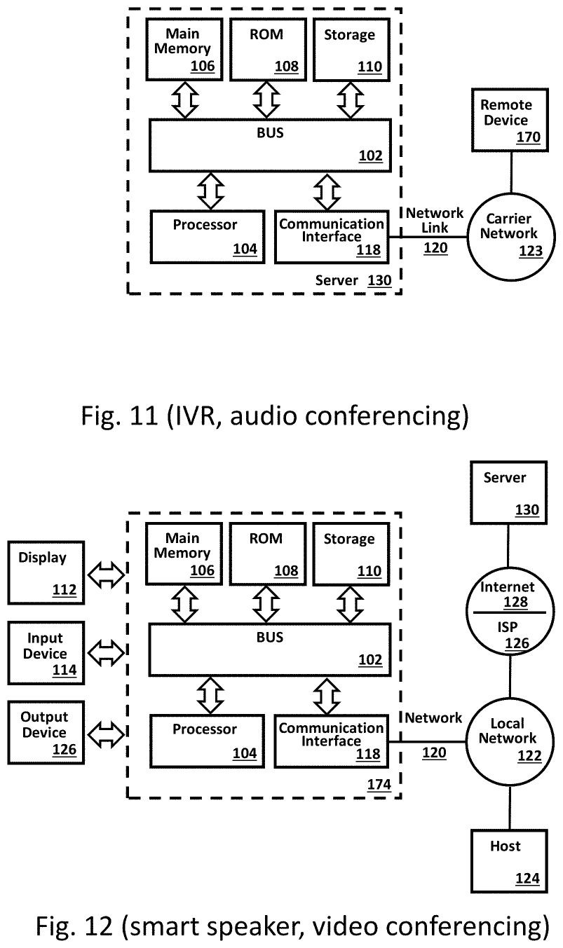

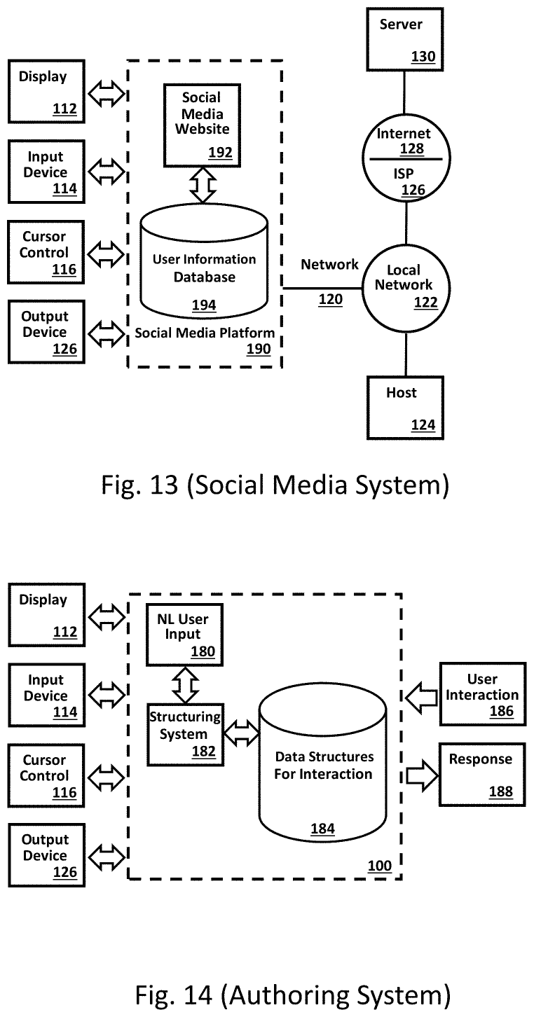

FIGS. 2-14 describe other aspects of embodiments.

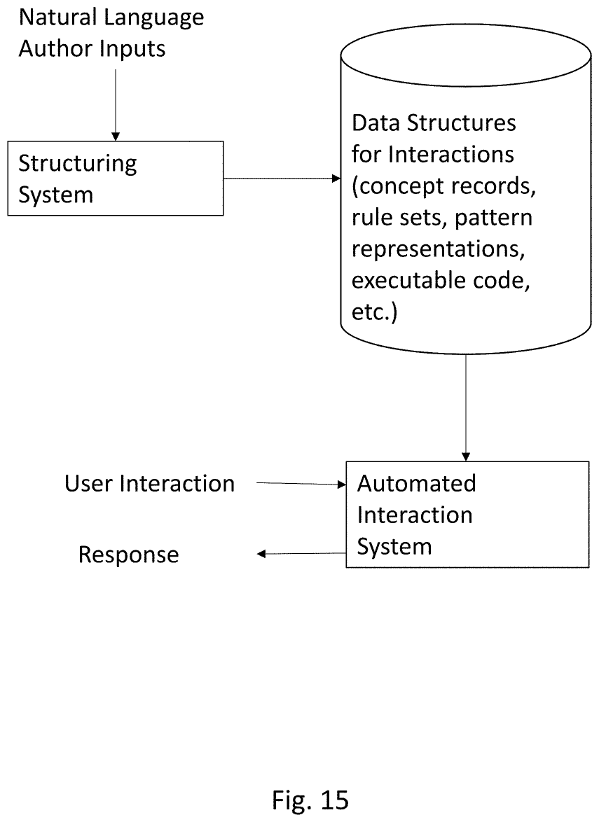

FIG. 15 illustrates a system in which a structuring system generates data usable by an automated interaction system. As illustrated there, an author can provide natural language author inputs to a structuring system, such as an authoring system, that can build data structures, such as concept records, rule sets, pattern representations, and executable code that form operations of an automated interaction system, such as an automated conversation system, that takes in user inputs (which might be voice, text, data, etc.) and provides responsive outputs. The structuring system allows for the implementation of automated interaction systems that can be constructed without requiring detailed programming on the part of authors. In a specific example, natural language processing can be used in an authoring system that is building a question-and-answer system for a particular domain or use. The authoring system might interact with an author, such as by asking questions and getting author responses, processing those responses as natural language author inputs, store those as structured format data, and from that structured format data, compute concepts, patterns, rules, executable code or routines, etc. that would form an automated interactive system. Users could then use that automated interactive system to interact with.

Embodiments of the disclosure can be described in view of the following clauses:

1. A computer-implemented method for generating a conversation system, comprising:
under the control of one or more computer systems configured with executable instructions: prompting an authoring user to select a selected knowledge domain from a set of one or more knowledge domains;
receiving the authoring user's selection of the selected knowledge domain;
receiving authoring user input from the authoring user; and
converting the authoring user input into a plurality of text outputs in a structured form, usable by an authored automated integration system.
2. The method of clause 1, further comprising:
converting the authoring user input into a plurality of text outputs, wherein a first text output is a first output of a first recognition system and a second text output is a second output of a second recognition system;
creating a domain-specific plan based on a domain specification of the selected knowledge domain;
obtaining a run-time specification, the run-time specification comprising a plan task flow configured for the selected knowledge domain and based on the domain-specific plan;
executing the plan task flow;
generating input values from the user input;
improving the conversation system based on the input values; and
storing a representation of the conversation system in computer-readable memory.
3. The method of clause 1 or 2, wherein the input from the authoring user comprises a voice input or a text input.
4. The method of any of clauses 1-3, wherein the first recognition system and the second recognition system are one or more of an automated speech recognition system or an image recognition system.
5. The method of any of clauses 1-4, further comprising dynamically revising the plan task flow using the reasoning module and based upon input from an interacting user interacting with the conversation system.
6. The method of any of clauses 1-5, further comprising:
obtaining, from the authoring user, a first authoring user selection of a selected option from among a first set of one or more first options;
adjusting the plan task flow based on the first authoring user selection; and
creating a stored domain knowledge repository using a data mining module.
7. The method of clause 6, wherein the data mining module uses one or more of structured text, unstructured text, and/or graphics, and computations of the data mining module alters outputs of the conversation system.
8. The method of any of clauses 1-7, wherein the domain-specific plan is generated using an automated domain knowledge source module with a crowd-sourced knowledge source ranking system, the method further comprising:
deriving a scoring value for each of a plurality of knowledge sources;
using the automated domain knowledge source module to dynamically determine a selected source to use from among a plurality of sources based on the scoring values; and
mapping the selected source to an output value of the conversation system.
9. A system for a dynamically improving a conversation program based on user input, the system comprising:
one or more processors; and
a non-transitory computer readable medium storing a plurality of instructions, which when executed, cause the one or more processors to:
a) form an intent based on a user input;
b) create a plan based on the intent, wherein the plan comprises a first action object that transforms a first concept object associated with the intent into a second concept object and comprises a second action object that transforms the second concept object into a third concept object associated with a goal of the intent, wherein the first action object and the second action object are selected from a plurality of action objects, and wherein the first action object is provided by a first third-party developer and the second action object is provided by a second third-party developer;
c) execute the plan, and
d) output a value associated with the third concept object.
10. The system of clause 9, wherein the first concept object is provided by a third third-party developer, the second concept object is provided by a fourth third-party developer, and the third concept object is provided by a fifth third-party developer.
11. The system of clause 9 or 10, wherein the first concept object comprises first data which provides instantiations of the first concept object, the second concept object comprises second data which provides instantiations of the second concept object, and the third concept object comprises third data which provides instantiations of the third concept object.
12. The system of of any of clauses 9-11, wherein an input parameter of the first action object is mapped to a web service parameter and a web service result is mapped to an output value of the first action object.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for generating a conversation system, comprising:
under the control of one or more computer systems configured with executable instructions:
prompting an authoring user to select a selected knowledge domain from a set of one or more knowledge domains;
receiving the authoring user's selection of the selected knowledge domain;
receiving authoring user input from the authoring user; and
converting the authoring user input into a plurality of text outputs in a structured form, usable by an authored automated integration system.

2. The method of claim 1, further comprising:
converting the authoring user input into a plurality of text outputs, wherein a first text output is a first output of a first recognition system and a second text output is a second output of a second recognition system;
creating a domain-specific plan based on a domain specification of the selected knowledge domain;
obtaining a run-time specification, the run-time specification comprising a plan task flow configured for the selected knowledge domain and based on the domain-specific plan;
executing the plan task flow;
generating input values from the user input;
improving the conversation system based on the input values; and
storing a representation of the conversation system in computer-readable memory.

3. The method of claim 1, wherein the input from the authoring user comprises a voice input or a text input.

4. The method of claim 1, wherein the first recognition system and the second recognition system are one or more of an automated speech recognition system or an image recognition system.

5. The method of claim 1, further comprising dynamically revising the plan task flow using the reasoning module and based upon input from an interacting user interacting with the conversation system.

6. The method of claim 1, further comprising:
obtaining, from the authoring user, a first authoring user selection of a selected option from among a first set of one or more first options;
adjusting the plan task flow based on the first authoring user selection; and
creating a stored domain knowledge repository using a data mining module.

7. The method of claim 6, wherein the data mining module uses one or more of structured text, unstructured text, and/or graphics, and computations of the data mining module alters outputs of the conversation system.

8. The method of claim 1, wherein the domain-specific plan is generated using an automated domain knowledge source module with a crowd-sourced knowledge source ranking system, the method further comprising:
deriving a scoring value for each of a plurality of knowledge sources;
using the automated domain knowledge source module to dynamically determine a selected source to use from among a plurality of sources based on the scoring values; and
mapping the selected source to an output value of the conversation system.

9. A system for a dynamically improving a conversation program based on user input, the system comprising:
one or more processors; and
a non-transitory computer readable medium storing a plurality of instructions, which when executed, cause the one or more processors to:
a) form an intent based on a user input;
b) create a plan based on the intent, wherein the plan comprises a first action object that transforms a first concept object associated with the intent into a second concept object and comprises a second action object that transforms the second concept object into a third concept object associated with a goal of the intent, wherein the first action object and the second action object are selected from a plurality of action objects, and wherein the first action object is provided by a first third-party developer and the second action object is provided by a second third-party developer;
c) execute the plan, and
d) output a value associated with the third concept object.

10. The system of claim 9, wherein the first concept object is provided by a third third-party developer, the second concept object is provided by a fourth third-party developer, and the third concept object is provided by a fifth third-party developer.

11. The system of claim 9, wherein the first concept object comprises first data which provides instantiations of the first concept object, the second concept object comprises second data which provides instantiations of the second concept object, and the third concept object comprises third data which provides instantiations of the third concept object.

12. The system of claim 9, wherein an input parameter of the first action object is mapped to a web service parameter and a web service result is mapped to an output value of the first action object.
